(19) United States
(12) Patent Application Publication
(10) Pub. No.: US 2025/0020816 A1
(43) Pub. Date: Jan. 16, 2025

(54) SYSTEMS AND METHODS FOR SUPPRESSING X-RAY INTERFERENCE IN RADIATION PORTAL MONITORS

(71) Applicant: Smiths Detection Inc., Edgewood, MD (US)

(72) Inventor: Pavlo BATURIN, Kingwood, TX (US)

(21) Appl. No.: 18/704,729

(22) PCT Filed: Oct. 26, 2022
(86) PCT No.: PCT/US2022/047801

§ 371 Date: Apr. 25, 2024

Related U.S. Application Data
(60) Provisional application No. 63/271,796, filed on Oct. 26, 2021.

(51) Int. Cl. G01T 1/208; H01J 43/18

(52) U.S. Cl. CPC G01T 1/208; H01J 43/18

(57) ABSTRACT

Systems and methods for suppressing X-ray interference in radiation portal monitors are provided. A radiation portal monitor includes a scintillator configured to convert high energy photons into low energy photons, and a photomultiplier tube (PMT) coupled to the scintillator, the PMT including a photocathode configured to convert the low energy photons into electrons, and a series of dynodes configured to cascade the electrons to facilitate detecting gamma events. The radiation portal monitor further includes an electron deflecting arrangement configured to selectively deflect the electrons before they encounter the series of dynodes.

### BACKGROUND

The embodiments described herein relate generally to radiation portal monitors (RPMs), and more particularly, to suppressing X-ray interference in RPMs.

RPMs are generally designed to detect the presence of nuclear or radiological materials. When an RPM is operated in the close proximity to an X-ray source, a gamma detector on the RPM may sense X-ray radiation from the X-ray source, resulting in the RPM mistakenly characterizing the X-ray radiation as gamma event emitted by a radioactive source. This characterization is undesirable, as it causes false alarms in the system (which may in turn introduce delays in scanning objects).

In at least some known systems, to address this issue, gamma detection by the RPM is paused during an X-ray event from the X-ray source. This approach may be referred to as “blanking”. Specifically, in this approach, the RPM is synchronized with a trigger of the X-ray event, so that the RPM detects, but does not count, the X-ray event. This results in effectively vetoing X-ray events, and only counting legitimate gamma events associated with radioactive sources. Although this approach is relatively efficient, there are some drawbacks. Notably, during the blanking window, the RPM does not count any legitimate gamma events that occur, resulting in a dead time for the system. Further, X-ray events can saturate the gamma detector of the RPM, creating a paralyzing effect for a period of time.

The dead time depends on the width of the blanking window and the frequency of the X-ray pulses. For example, many high energy X-ray sources operate at relatively high frequencies (e.g., 1 kHz), which increases the extent of the paralyzing effect and therefore reduces the ability of the RPM to detect radiological threats. Further, the paralyzing effect prevents making the blanking window relatively small, limiting the performance of the RPM.

Accordingly, it would be desirable to suppress X-ray interference, while still maintaining performance of the RPM.

### BRIEF SUMMARY

In one aspect, a radiation portal monitor is provided. The radiation portal monitor includes a scintillator configured to convert high energy photons into low energy photons, and a photomultiplier tube (PMT) coupled to the scintillator, the PMT including a photocathode configured to convert the low energy photons into electrons, and a series of dynodes configured to cascade the electrons to facilitate detecting gamma events. The radiation portal monitor further includes an electron deflecting arrangement configured to selectively deflect the electrons before they encounter the series of dynodes.

In another aspect, a method of operating a radiation portal monitor is provided. The method includes converting high energy photons into low energy photons using a scintillator, converting the low energy photons into electrons using a photocathode of a photomultiplier tube (PMT), and selectively deflecting, using an electron deflecting arrangement, at least some of the electrons before they encounter a series of dynodes of the PMT.

In yet another aspect, a method of suppressing X-ray interference for a radiation portal monitor is provided. The method includes detecting an X-ray event, characterizing a pulse of the X-ray event, and suppressing subsequent X-ray pulses based on the characterized pulse.

### BRIEF DESCRIPTION OF THE DRAWINGS

FIG. 1 is a schematic diagram of an example embodiment of a radiation portal monitor (RPM).

FIG. 2 is a graph illustrating a signal response of a photomultiplier tube (PMT) to an X-ray event.

FIG. 3A is a graph illustrating a signal response of a PMT to multiple X-ray events.

FIG. 3B is a graph illustrating triggering based on X-ray events.

FIG. 4 is a schematic diagram of an example embodiment of an electron deflecting arrangement.

FIG. 5 is a schematic diagram of another example embodiment of an electron deflecting arrangement.

FIG. 6 is a schematic diagram of another example embodiment of an electron deflecting arrangement.

FIG. 7 is a flow diagram of one example embodiment of a method for suppressing X-ray interference.

FIG. 8 is a block diagram of an example computing device that may be used to implement the method shown in FIG. 7.

### DETAILED DESCRIPTION

The present disclosure is directed to suppressing X-ray interference in radiation portal monitors. A radiation portal monitor includes a scintillator configured to convert high energy photons into low energy photons, and a photomultiplier tube (PMT) coupled to the scintillator, the PMT including a photocathode configured to convert the low energy photons into electrons, and a series of dynodes configured to cascade the electrons to facilitate detecting gamma events. The radiation portal monitor further includes an electron deflecting arrangement configured to selectively deflect the electrons before they encounter the series of dynodes.

A radiation portal monitor (RPM) is a passive radiation detection system designed to provide non-intrusive means of screening vehicles, people, or other objects for the presence of nuclear or radiological materials. As discussed above, high frequency pulsed X-ray sources (such as X-ray imaging systems) may interfere with gamma detection capabilities of RPMs.

At least some known implementations for suppressing X-ray interference have limitations. For example, in one known technique, a counter on the RPM is disabled during an X-ray event. This is referred to as “blanking”. When blanking, however, the RPM is also unable to detect any legitimate gamma events. For example, if a 100 microsecond (μs) blanking window is applied to gate off a 1 kHz pulsed X-ray source, the result is that the RPM is “blind” (i.e., unable to detect legitimate events) for 100 milliseconds (ms) per every second (i.e., 10% dead time). Further, RPM saturation creates limitations on how much the blanking window can be reduced.

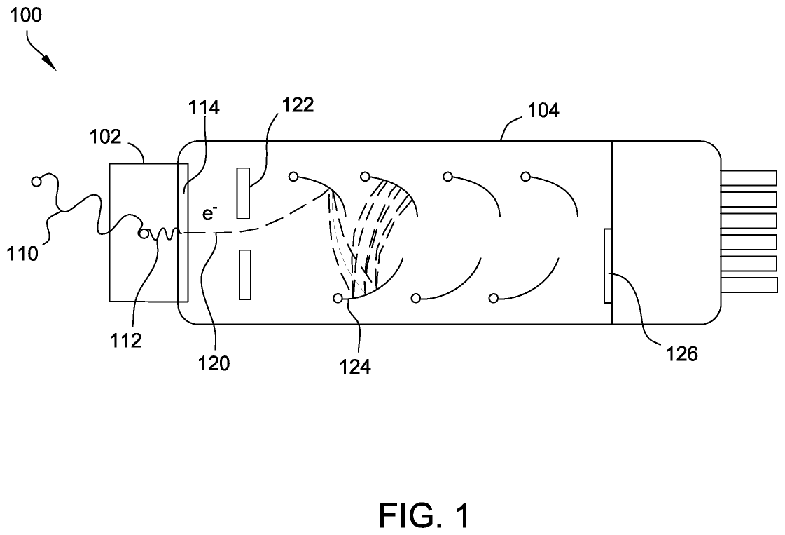

RPM systems typically include a gamma detector and a neutron detector. Gamma detectors measure photons emitted from radioactive materials. FIG. 1 is a schematic diagram of an example embodiment of an RPM 100. RPM 100 includes a scintillator 102 coupled to a photomultiplier tube (PMT) 104. During operation, high energy photons 110 (e.g., X-ray or gamma ray radiation) incident on scintillator 102 are converted into low energy photons 112 by scintillator 102. Low energy photons 112 then enter PMT 104 through a photocathode 114 that converts the low energy photons 112 into electrons 120. Subsequently, electrons 120 are directed by a focusing electrode 122 through a series of dynodes 124, greatly increasing the number of electrons 120. The large number of electrons 120 reaching an anode 126 generate a detectable current pulse, enabling RPM 100 to detect and count an event.

In the occurrence of an X-ray event, the X-ray photons are essentially indistinguishable from gamma photons that are emitted by radioactive sources. However, although PMT 104 may function well at the low emissions rates associated with radioactive source gamma events, high energy X-ray events may saturate PMT 104. The saturated signal temporarily paralyzes the electronics of RPM 100 and creates overshoot effects.

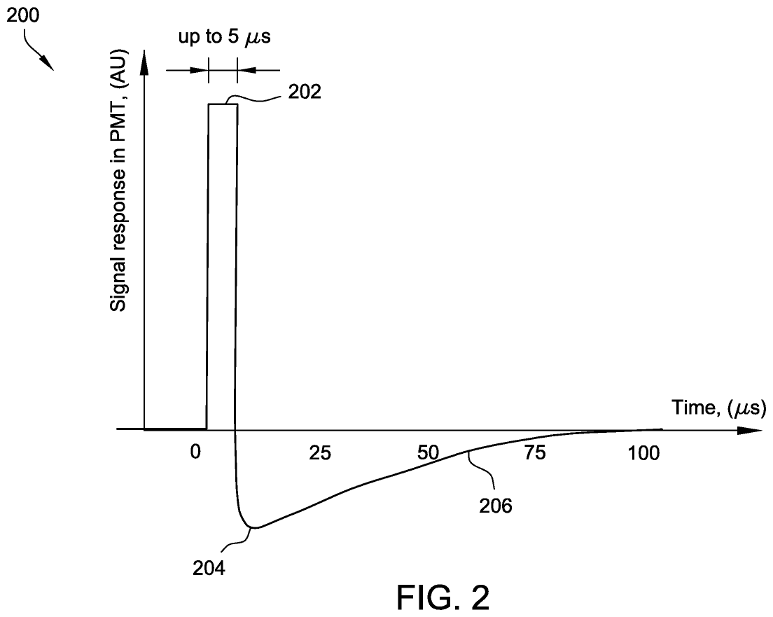

For example, FIG. 2 is a graph 200 illustrating a signal response of PMT 104 to an X-ray event. As shown in FIG. 2, the X-ray event causes a signal spike 202, followed by an overshoot 204 that has a relatively length recovery tail 206 to return to zero. Overshoot 204 relates to an alternating current (AC) coupling effect, and may be addressed by adjusting capacitance values on affected electronics. This may help mitigate overshoot 204, but will not completely eliminate it.

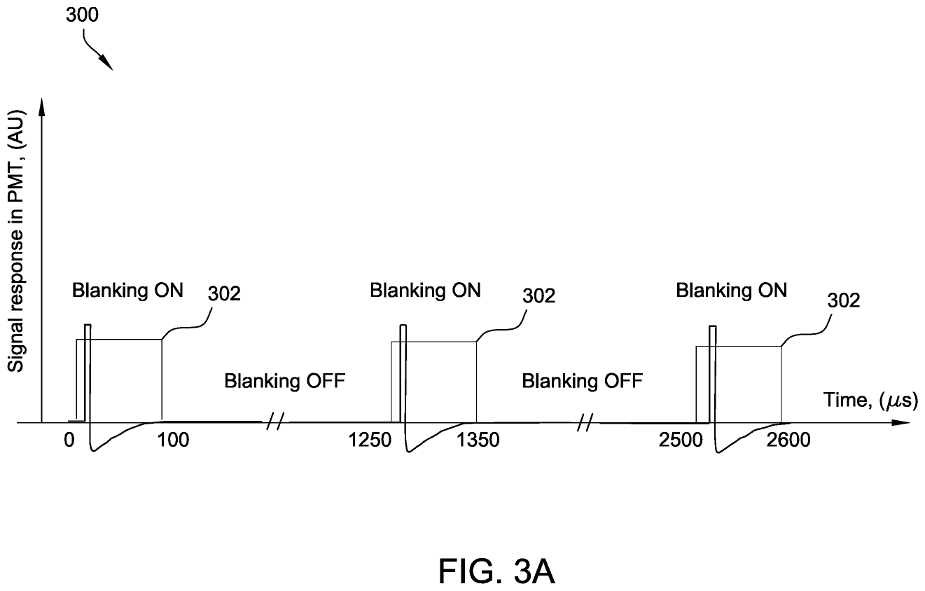

When using a blanking approach, the blanking window should take overshoot 204 and the corresponding recovery tail 206 into account. FIG. 3A is a graph 300 illustrating a signal response of PMT 104 to multiple X-ray events. As shown in FIG. 3, blanking windows 302 are wide enough to cover spike 202, overshoot 204, and recovery tail 206 of each X-ray event. Accordingly, although spike 202 may be relatively short (e.g., 5 μs), overshoot 204 and recovery tail 206 cause blanking windows 302 to be relatively long (e.g., 100 μs).

To minimize the effects of saturation and long relaxation time, the embodiments described herein suppress X-ray interference in a PMT (such as PMT 104) using external forces. That is, the systems and methods described herein use external electric and/or magnetic forces to act on electrons emitted from a photocathode (such as electrons 120 emitted from photocathode 114) during an X-ray event to prevent those electrons from reaching dynodes (such as dynodes 124). The external forces stir the electrons such that they miss the dynodes or strike the dynodes in an unfavorable location that is not conducive to avalanche multiplication. This prevents saturation of the PMT, reducing or eliminating the overshoot effect.

Specifically, in at least some embodiments, the external forces stir or deflect electrons during X-ray events (i.e., the deflection is synchronized with the occurrence of the X-ray events). This prevents saturation of the PMT. Accordingly, because the deflection only occurs during the actual X-ray event (e.g., during the length of signal spike 202), disruption of operation of the PMT in detecting legitimate events is reduced significantly, as compared to the blanking approaches described above.

The triggering of the externally induced forces should be synchronized with an X-ray trigger signal. For example, FIG. 3B is a graph 350 illustrating relative timings of corresponding X-ray triggers 352, X-ray pulses 354, and blanking windows 356. In the example embodiment, the activation and deactivation of the external forces should coincide with or be very close to the beginning and end of each X-ray trigger 352.

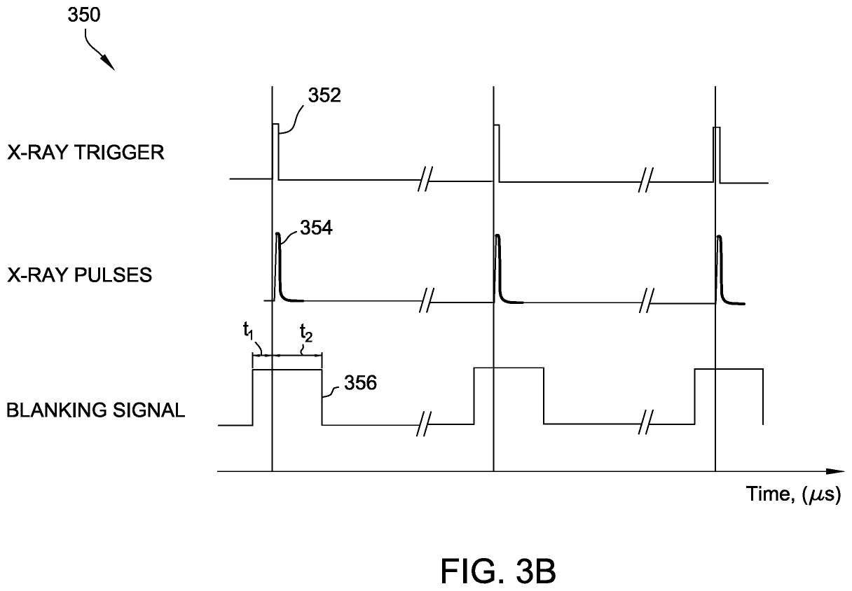

FIG. 4 is a schematic diagram of one example embodiment of an electron deflecting arrangement 400. Arrangement 400 includes a PMT 402 (such as PMT 104), and a pair of Helmholtz coils 404. Running a current through Helmholtz coils 404 generates a lateral magnetic field 410 that is generally perpendicular to a longitudinal axis 412 of PMT 402. Accordingly, electrons 420 initially travelling towards dynodes 124 may be deflected by lateral magnetic field 410, causing those electrons 420 to miss dynodes 124. However, in some situations, PMT 402 may include a hollow, annular cap 430 made of a high magnetic permeability material to prevent magnetic interference. Cap 430 may partially or fully shield electrons 420 from lateral magnetic field 410, reducing the effectiveness of lateral magnetic field 410 in deflecting electrons 420.

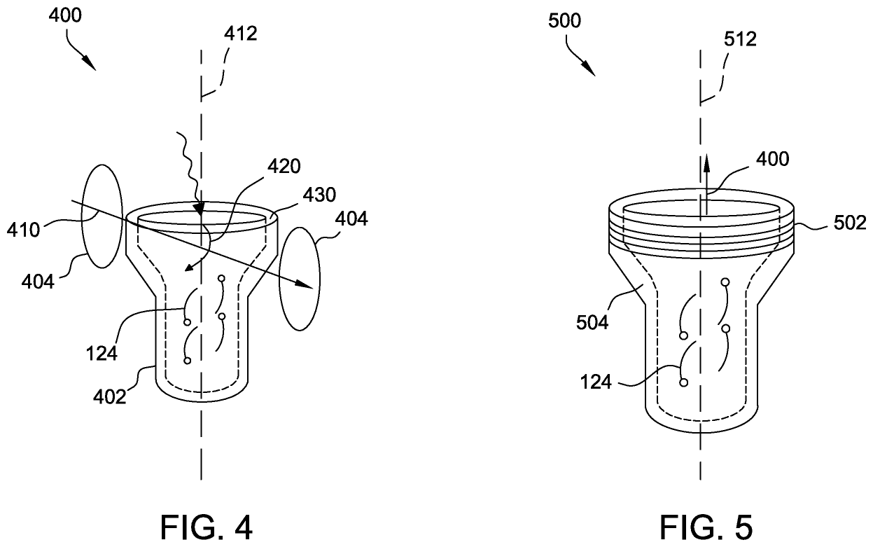

FIG. 5 is a schematic diagram of another example embodiment of an electron deflecting arrangement 500. In arrangement 500, a bucking coil 502 extends around a portion of PMT 504. In arrangement 400, running a current through bucking coil 502 generates a longitudinal magnetic field 506 (i.e., a magnetic field along a longitudinal axis 512 of PMT 504. Given the location and orientation of bucking coil 502, longitudinal magnetic field 506 disrupts electrons that would otherwise reach dynodes 124. For example, to effectively deflect electrons, a focal distance of bucking coil 502 is relatively short such that it is positioned between the photocathode and the first dynode.

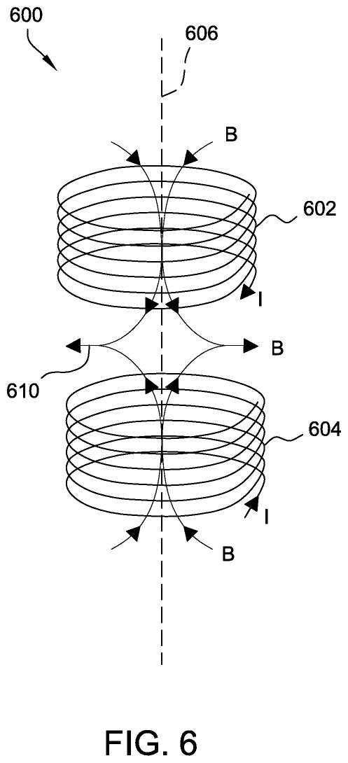

FIG. 6 is a schematic diagram of yet another example embodiment of an electron deflecting arrangement 600. Arrangement 600 includes a first solenoid coil 602 an a second solenoid coil 604 surrounding and aligned with a longitudinal axis 606 of the PMT (not shown in FIG. 6). Running a current through first and second solenoid coils 602 and 604 generates a radial magnetic field 610 (i.e., radially outward from longitudinal axis 606) that disrupts electrons that would otherwise reach the dynodes.

Those of skill in the art that the arrangements 400, 500, and 600 shown in FIGS. 4-6 are examples, and that other suitable electron deflecting arrangements fall within the spirit and scope of this disclosure (including electron deflecting arrangements that do not include coils). Further, to model the deflection capabilities of arrangements 400, 500, and 600, a thin electromagnetic lens model acting on blue optical photons may be considered as a good approximation. For example, using such a model, it was determined that running a current of 2.5 Amps (A) through ten windings of a coil structure will focus (or deflect) electrons at a distance of approximately 0.4 centimeters (cm) from a center of the coil structure.

The deflecting arrangements described herein facilitate reduction or completing elimination of PMT saturation, which causes the recovery tail associated with saturation to shorten or disappear entirely. A shorter recovery time allows for smaller blanking windows, reducing dead time when the RPM is unable to detect legitimate gamma events. Further, reducing or eliminating saturation lessens the risk of damage to the PMT that may occur during saturation. As described herein, if a pulsed X-ray source is synchronized with a trigger for one of the deflecting arrangements described herein, saturation suppression is controllable.

In some embodiments, other approaches are used to suppress X-ray interference. For example, in one embodiment, potentials on a focusing electrode of the PMT (such as focusing electrode 122 of PMT 104, both shown in FIG. 1) may be controlled to deflect or defocus electrons during X-ray events. In another embodiment, a gain in a series of dynodes (such as dynodes 124, shown in FIG. 1) can be altered during X-ray events to reduce overall gain of the PMT, which will prevent the PMT from saturating.

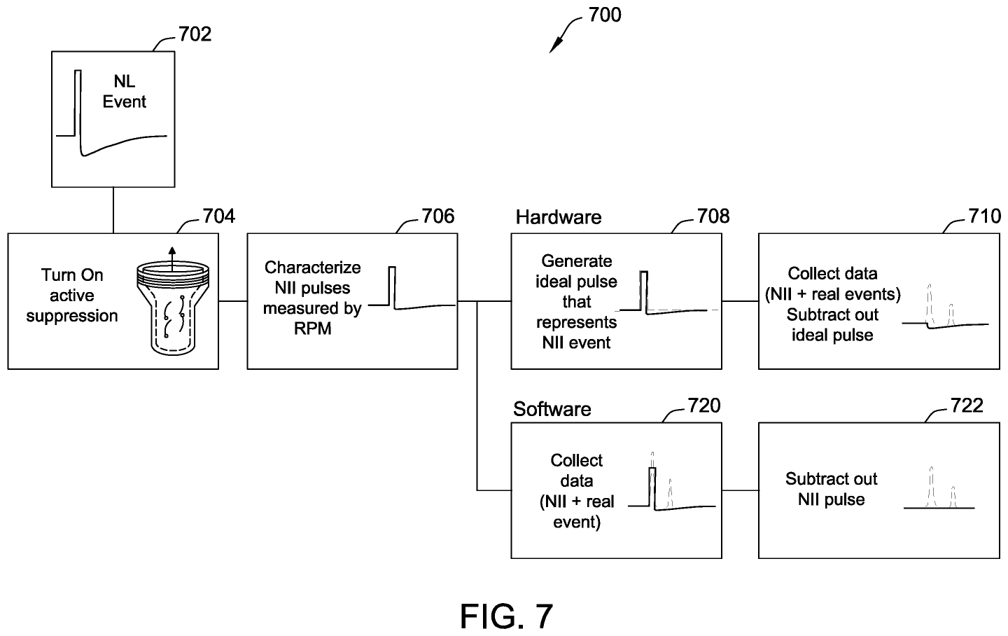

As another example, FIG. 7 is a flow diagram of an example embodiment of a method 700 for suppressing X-ray interference. As explained herein, method 700 does not involve blanking, but utilizes hardware/software implementations to achieve active suppression.

At block 702, an X-ray event occurs (also referred to herein as a Non-Intrusive Imaging (NII) event). Subsequently, at block 704, active suppression (e.g., using one of arrangements 400, 500, and 600) is activated. At block 706, pulses of the NII event (measured by the RPM) are analyzed and characterized. Then, based on the characterization, the suppression may be carried out using hardware or software techniques.

For example, for a hardware implementation, based on the characterization of the NII event, an ideal pulse that represents the event is generated at block 708. At block 710, data (including a subsequent NII event and legitimate gamma events) is collected, and the ideal pulse is subtracted from the collected data. Assuming the subsequent NII event is substantially similar to the characterized NII event, subtracting the ideal pulse from the collected data essentially removes the subsequent NII event from the data.

In an example software implementation (e.g., using a processor communicatively coupled to a memory device), data (including a subsequent NII event and legitimate gamma events) is collected at block 720. Subsequently, based on the characterized NII event, the pulse corresponding to the subsequent NII event is subtracted out of the collected data at block 722. Notably, using either subtraction technique eliminates the PMT response to the X-ray pulses, and keeps the PMT signal at background or normal operational levels during the X-ray event. Accordingly, using these embodiments, blanking techniques are no longer required.

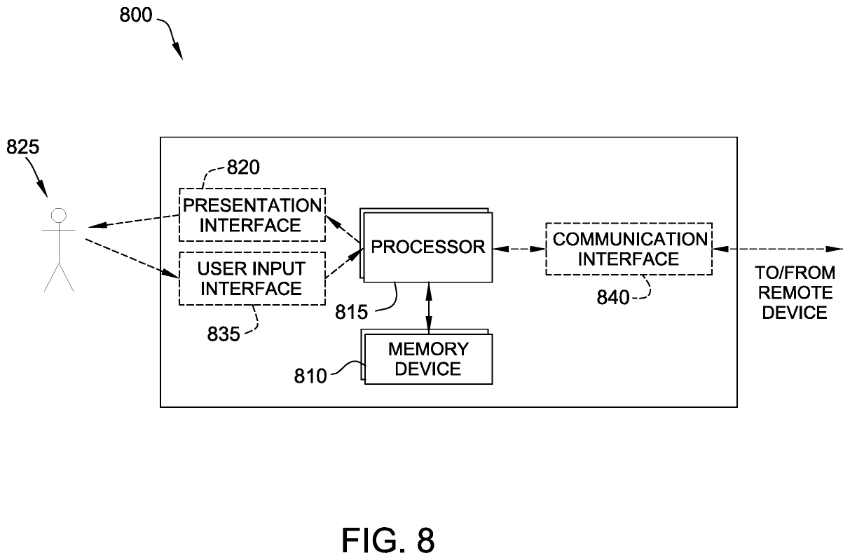

FIG. 8 is a block diagram of a computing device 800 that may be used to implement method 700. Computing device 800 includes at least one memory device 810 and a processor 815 that is coupled to memory device 810 for executing instructions. In some embodiments, executable instructions are stored in memory device 810. In the exemplary embodiment, computing device 800 performs one or more operations described herein by programming processor 815. For example, processor 815 may be programmed by encoding an operation as one or more executable instructions and by providing the executable instructions in memory device 810.

Processor 815 may include one or more processing units (e.g., in a multi-core configuration). Further, processor 815 may be implemented using one or more heterogeneous processor systems in which a main processor is present with secondary processors on a single chip. In another illustrative example, processor 815 may be a symmetric multi-processor system containing multiple processors of the same type. Further, processor 815 may be implemented using any suitable programmable circuit including one or more systems and microcontrollers, microprocessors, reduced instruction set circuits (RISC), application specific integrated circuits (ASIC), programmable logic circuits, field programmable gate arrays (FPGA), graphics processing units (GPU), and any other circuit capable of executing the functions described herein.

In the exemplary embodiment, memory device 810 is one or more devices that enable information such as executable instructions and/or other data to be stored and retrieved. Memory device 810 may include one or more computer readable media, such as, without limitation, dynamic random access memory (DRAM), static random access memory (SRAM), a solid state disk, and/or a hard disk. Memory device 810 may be configured to store, without limitation, application source code, application object code, source code portions of interest, object code portions of interest, configuration data, execution events and/or any other type of data.

In the exemplary embodiment, computing device 800 includes a presentation interface 820 that is coupled to processor 815. Presentation interface 820 presents information to a user 825. For example, presentation interface 820 may include a display adapter (not shown) that may be coupled to a display device, such as a cathode ray tube (CRT), a liquid crystal display (LCD), an organic LED (OLED) display, and/or an “electronic ink” display. In some embodiments, presentation interface 820 includes one or more display devices.

In the exemplary embodiment, compression device 800 includes a user input interface 835. User input interface 835 is coupled to processor 815 and receives input from user 825. User input interface 835 may include, for example, a keyboard, a pointing device, a mouse, a stylus, a touch sensitive panel (e.g., a touch pad or a touch screen), a gyroscope, an accelerometer, a position detector, and/or an audio user input interface. A single component, such as a touch screen, may function as both a display device of presentation interface 820 and user input interface 835.

Computing device 800, in this embodiment, further includes a communication interface 840 coupled to processor 815. Communication interface 840 communicates with one or more remote devices. To communicate with remote devices, communication interface 840 may include, for example, a wired network adapter, a wireless network adapter, and/or a mobile telecommunications adapter.

Example embodiments of suppressing X-ray interference in radiation portal monitors are described herein. A radiation portal monitor includes a scintillator configured to convert high energy photons into low energy photons, and a photomultiplier tube (PMT) coupled to the scintillator, the PMT including a photocathode configured to convert the low energy photons into electrons, and a series of dynodes configured to cascade the electrons to facilitate detecting gamma events. The radiation portal monitor further includes an electron deflecting arrangement configured to selectively deflect the electrons before they encounter the series of dynodes.

Although specific features of various embodiments of the invention may be shown in some drawings and not in others, this is for convenience only. In accordance with the principles of the invention, any feature of a drawing may be referenced and/or claimed in combination with any feature of any other drawing.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A radiation portal monitor comprising:
a scintillator configured to convert high energy photons into low energy photons;
a photomultiplier tube (PMT) coupled to said scintillator, said PMT comprising:
a photocathode configured to convert the low energy photons into electrons; and
a series of dynodes configured to cascade the electrons to facilitate detecting gamma events; and
an electron deflecting arrangement configured to selectively deflect the electrons before they encounter said series of dynodes.

2. The radiation portal monitor of claim 1, wherein said electron deflecting arrangement comprises at least one coil.

3. The radiation portal monitor of claim 2, wherein said at least one coil is configured to selectively deflect electrons in synch with X-ray pulses emitted from an X-ray source.

4. The radiation portal monitor of claim 2, wherein said at least one coil comprises a pair of coils positioned and oriented to generate a lateral magnetic field that is perpendicular to a longitudinal axis of said PMT.

5. The radiation portal monitor of claim 2, wherein said at least one coil comprises a bucking coil positioned and oriented to generate a longitudinal magnetic field that is aligned with a longitudinal axis of said PMT.

6. The radiation portal monitor of claim 2, wherein said at least one coil comprises a first coil and a second coil positioned and oriented to generate a radially outward magnetic field relative to a longitudinal axis of said PMT.

7. The radiation portal monitor of claim 2, wherein said at least one coil is arranged such that electromagnetic forces generated by said at least one coil act on the electrons to destructively affect a trajectory of the electrons and cause signal reduction in said PMT.

8. The radiation portal monitor of claim 1, wherein said PMT further comprises a focusing electrode configured to direct the electrons toward said series of dynodes, said focusing electrode further configured to selectively defocus the electrons during X-ray events.

9. The radiation portal monitor of claim 1, wherein said PMT is configured to selectively adjust a gain of said series of dynodes to prevent saturation of said PMT during X-ray events.

10. A method of operating a radiation portal monitor, said method comprising:
converting high energy photons into low energy photons using a scintillator;
converting the low energy photons into electrons using a photocathode of a photomultiplier tube (PMT); and
selectively deflecting, using an electron deflecting arrangement, at least some of the electrons before they encounter a series of dynodes of the PMT.

11. The method of claim 10, wherein selectively deflecting at least some of the electrons comprises selectively deflecting at least some of the electrons in synch with X-ray pulses emitted from an X-ray source.

12. The method of claim 10, wherein selectively deflecting at least some of the electrons comprises selectively deflecting at least some of the electrons using a pair of coils positioned and oriented to generate a lateral magnetic field that is perpendicular to a longitudinal axis of the PMT.

13. The method of claim 10, wherein selectively deflecting at least some of the electrons comprises selectively deflecting at least some of the electrons using a bucking coil positioned and oriented to generate a longitudinal magnetic field that is aligned with a longitudinal axis of the PMT.

14. The method of claim 10, wherein selectively deflecting at least some of the electrons comprises selectively deflecting at least some of the electrons using a first coil and a second coil positioned and oriented to generate a radially outward magnetic field relative to a longitudinal axis of said PMT.

15. The method of claim 10, wherein selectively deflecting at least some of the electrons acting on the electrons using electromagnetic forces generated by at least one coil to destructively affect a trajectory of the electrons and cause signal reduction in the PMT.

16. The method of claim 10, further comprising selectively defocusing a subset of the electrons during X-ray events using a focusing electrode of the PMT.

17. The method of claim 10, further comprising selectively adjusting a gain of the series of dynodes to prevent saturation of the PMT during X-ray events.

18. A method of suppressing X-ray interference for a radiation portal monitor, the method comprising:
detecting an X-ray event;
characterizing a pulse of the X-ray event; and
suppressing subsequent X-ray pulses based on the characterized pulse.

19. The method of claim 18, wherein suppressing subsequent X-ray pulses comprises:
generating an ideal pulse based on the characterized pulse;
collecting data including a subsequent X-ray pulse; and
subtracting the ideal pulse from the collected data.

20. The method of claim 18, wherein suppressing subsequent X-ray pulses comprises:
collecting data including a subsequent X-ray pulse; and
subtracting the subsequent X-ray pulse out of the collected data, based the characterized pulse.
